(19) United States
(12) Patent Application Publication
(10) Pub. No.: US 2017/0102225 A1
(43) Pub. Date: Apr. 13, 2017

(54) SYSTEM AND METHOD FOR NON-DESTRUCTIVE LAYER DETECTION

(71) Applicant: Consolidated Container Company, Atlanta, GA (US)

(72) Inventors: Joey Arlin Palmer, Marietta, GA (US); Panagiotis Giannakakos, Smyrna, GA (US)

(21) Appl. No.: 14/877,303

(22) Filed: Oct. 7, 2015

(51) Int. Cl. G01B 11/06; G01N 21/64; B65D 1/40

(52) U.S. Cl. CPC G01B 11/06; B65D 1/40; G01N 21/6428; G01N 2021/6439

(57) ABSTRACT

A blow molded container comprising a multi-layer laminate wall, said wall comprising a first layer comprising an extrusion blow-molding-capable grade of polymer, the first layer being an inner surface layer of the wall, a second, interior layer, the second layer, a third layer comprising an extrusion blow-molding-capable grade of polymer, and a detectable optical marker embedded in one of the first layer, the second interior layer, or the third layer, wherein said second layer is disposed between said first and third layers. A method of detecting a layer within a blow molded container, comprising shining an incident electromagnetic radiation on a multilayer laminate container, measuring an exit radiation from the multilayer laminate container, and determining if a particular layer having a detectable optical marker embedded therein exists and/or if a sufficient thickness the particular layer exists from characteristics of the exit radiation.

### BACKGROUND

The present invention relates generally to blow molded wall containers and packages and in particular to the addition of a marker (additive) to barrier layers in multi-layer packaging to create a detectable confirmation that the barrier layer is present and formed of a certain thickness of the material.

Monolayer Polyethylene terephthalate (PET), High Density Polyethylene (HDPE) and

Polypropylene (PP) containers have clarity, gloss, and oxygen and scalping barrier properties. In many cases, such as when the container is used to store food products such as orange juice, it is desirable for the container to have barrier properties that are conducive to, for example, maintaining the original flavor and nutrient content of the food product (e.g. preventing flavor scalping), to prevent migration of odors into and out of the container, and to prevent the product from spoiling. Conventionally, container integrity, such as the presence of the barrier layer, is determined by destructive methods such as biotest, electrolytic test, dye penetration tests and bubble tests. The major drawbacks of destructive test methods are that it is not possible to check every package, and the tests are labor intensive and result in destroyed samples.

### SUMMARY OF THE INVENTION

Exemplary embodiments include a blow molded container comprising a wall, said wall including a first layer comprising an extrusion blow-molding-capable grade of polymer such as extrudable PET, HDPE, PP or other suitable polymers, said first layer being an inner surface layer of said wall, a second, interior layer, said second layer comprising a detectable optical marker embedded in the second interior layer and a third layer comprising an extrusion blow- molding-capable grade of polymer, wherein said second layer is disposed between said first and third layers.

Additional exemplary embodiments include a method of detecting a layer within a blow molded container, the method including shining an incident electromagnetic radiation on a multilayer laminate structure, measuring an exit radiation from the multilayer laminate structure, and determining if there exists a sufficient thickness from characteristics of the exit radiation.

Additional exemplary embodiments include a blow molded container including a co-extruded, multi-layer, blow molded wall comprising at least one layer that comprises about 0.2% to about 10% of the total weight of the extruded wall of the container and a blend of an extrusion-blow-molding-capable grade of polymer, at least one barrier material having a detectable optical marker and regrind from at least a particular multi-layer container, said particular multi-layer container comprising at least one layer of an extrusion-blow-molding-capable grade of polymer.

Further exemplary embodiments include a layer thickness measurement syste including an electromagnetic radiation source, an electromagnetic radiation detector, a container, including, a first layer comprising an extrusion blow-molding-capable grade of polymer, said first layer being an inner surface layer of said wall, a second, interior layer, said second layer comprising a detectable optical marker embedded in the second interior layer and a third layer comprising an extrusion blow-molding-capable grade of polymer, wherein said second layer is disposed between said first and third layers, wherein electromagnetic radiation incident from the electromagnetic radiation source on the container generates exit electromagnetic radiation detected by the electromagnetic radiation detector, the exit radiation determining a thickness of any of the first second and third layers.

### BRIEF DESCRIPTION OF THE DRAWINGS

Various embodiments of an apparatus, system, and method for non-destructive layer detection are described below. In the course of this description, reference will be made to the accompanying drawings, which are not necessarily drawn to scale, and wherein:

FIG. 1 is a front, partial cross-sectional view of an exemplary plastic blow molded container according to particular embodiments of the invention

FIG. 2 shows a first alternative embodiment of the container wall 110 of FIG. 1;

FIG. 3 shows a second alternative embodiment of the container wall 110 of FIG. 1;

FIG. 4 shows a third alternative embodiment of the container wall 110 of FIG. 1;

FIG. 5 shows a fourth alternative embodiment of the container wall 110 of FIG. 1;

FIG. 6 illustrates a barrier layer thickness measurement system; and

FIG. 7 illustrates a flowchart for a method of detecting a barrier layer in a multilayer laminate in accordance with exemplary embodiments.

### DETAILED DESCRIPTION

Various embodiments now will be described more fully hereinafter with reference to the accompanying drawings. It should be understood that the present system and methods may be embodied in many different forms and should not be construed as limited to the embodiments set forth herein. Like numbers refer to like elements throughout.

### Overview

The present systems and methods now will be described more fully with reference to the accompanying drawings, in which some, but not all embodiments are shown. Indeed, this improved system and methods may be embodied in many different forms and should not be construed as limited to the embodiments set forth herein. Rather, these embodiments are provided so that this disclosure will satisfy applicable legal requirements. Like numbers refer to like elements throughout.

The systems and methods described herein enable the detection of a particular layer in a multilayer laminate, implementing a non-destructive system and method. The laminate may be any multi-layer packaging (e.g., containers, bottles, packaging trays, etc.) in which the presence or absence of a particular layer is to be detected. For illustrative purposes, the detection of a barrier layer in blow molded wall containers is described. It is appreciated that any multi-layer structure is contemplated in other embodiments. It is further appreciated that any layer other than the barrier layers can be detected. In exemplary embodiments, to detect the absence or presence of the barrier layers, an optical marker is embedded in the layer, which can be detected after manufacture. For example, the marker can be any florescent, photosensitive or optical material (e.g., IR, visible and UV) that reacts when a particular spectrum of light is illuminated upon the material. The marker can also be any chemical colorant embedded in the layer to be detected. In addition, depending on the absorbance or transmittance of the testing electromagnetic spectrum in the layer, the thickness of the layer can also be measured. In this way, with optical markers in each container to be tested, all containers can be tested in-line during the manufacture process without destroying the containers. At the same time, thicknesses of the layers can also be automatically tested. Depending on the frequency of thicknesses detected, operators can adjust the thicknesses of subsequent manufactured containers.

As described above, illustrative blow molded wall containers (e.g., bottles) according to various embodiments of the invention include a blow-molded wall that defines the container's external dimensions and separates the container's contents from the exterior environment. In particular embodiments, the wall is made by co-extruding different polymers simultaneously during the extrusion blow molding process. In particular embodiments, such polymers may include at least one extrusion blow-molding-capable grade of polymer, such as: (a) a copolyster of polyethylene terephthalates (EPET) (e.g., EBO62 sold by Eastman Chemical Company); or (b) a glycol-modified polyethylene terephthalate (PETG). This extrusion blow-molding-capable grade of polymer may be in separate layers and/or blends with at least one other polymer material. As further described herein, a marker can be embedded in any of the layers of the blow molded wall container to detect the presence or absence of the layer in question.

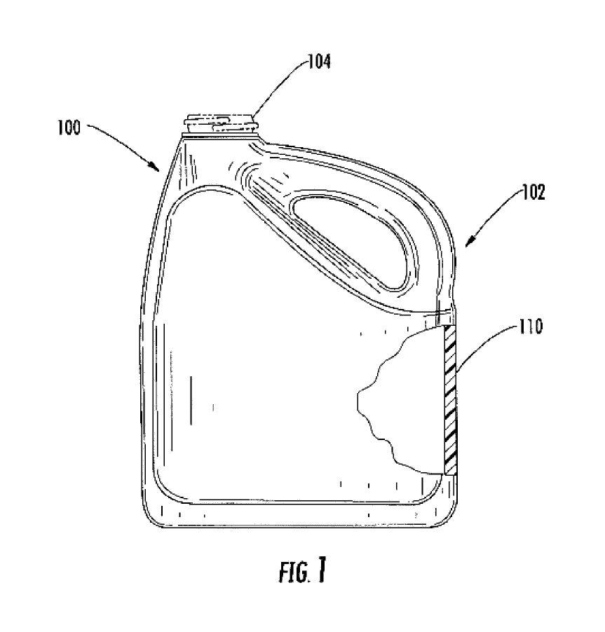

Various exemplary embodiments of the invention are discussed in greater detail below in regard to FIGS. 1-4. FIG. 1 is a front, partial cross-sectional view of an exemplary plastic blow molded container according to a particular embodiment of the invention. As may be understood from this figure, the container 100 includes a container body 102, container wall 110 and a finish 104.

### General Discussion Regarding Multi-Layer Laminate Blow Molded Containers

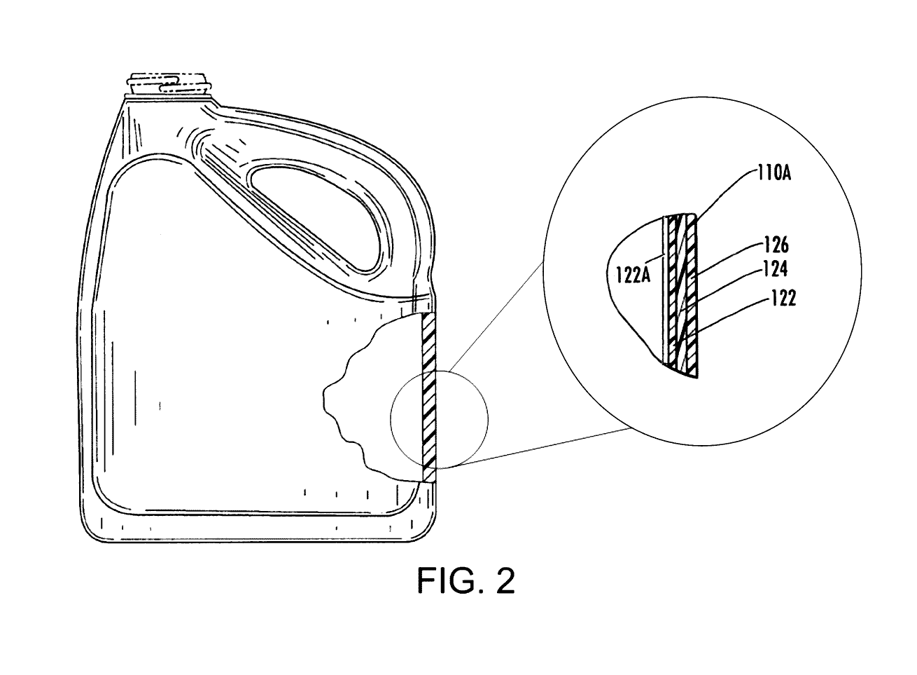

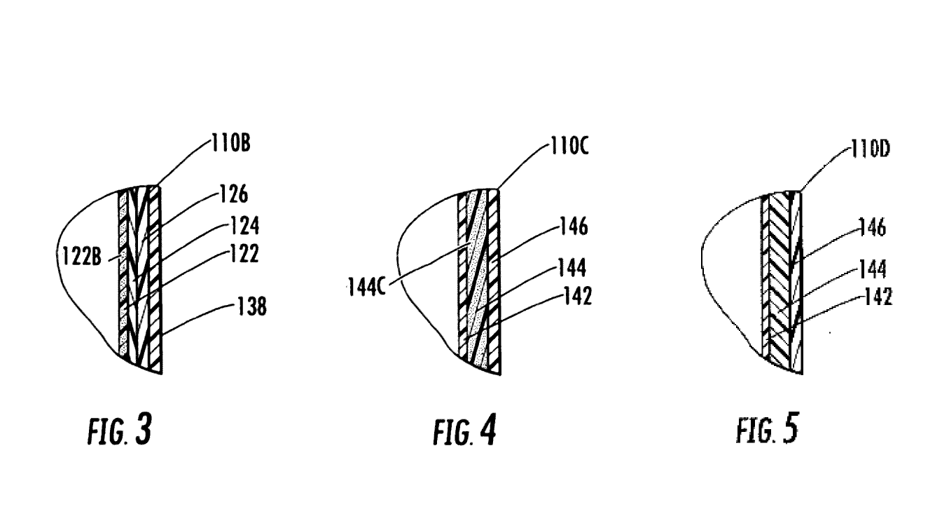

FIGS. 2-5 illustrate close-up cross sectional views of various alternative embodiments of the container wall 110 shown in FIG. 1. For example: FIG. 2 shows a first alternative embodiment 110A of the container wall 110 of FIG. 1 having a marker 122A embedded therein; FIG. 3 shows a second alternative embodiment 110B of the container wall 110 of FIG. 1 having a marker 122B embedded therein; FIG. 4 shows a third alternative embodiment 110C of the container wall 110 of FIG. 1 having a marker 144C; and FIG. 5 shows a fourth alternative embodiment 110D of the container wall 110 of FIG. 1.

Discussion of the Embodiments of FIGS. 2 and 3, and Other Related Embodiments

As may be understood from FIG. 2, a container according to various embodiments of the invention includes a container body having at least one co-extruded, blow molded wall 110A that comprises a first layer 122, a second layer 124, and a third layer 126. In the embodiment shown in FIG. 2, the first layer 122 is an inner surface layer of the container wall 110A and comprises (and, in various embodiments, consists of, and/or consists essentially of) an extrusion blow-molding-capable grade of polymer. Examples of such extrusion blow-molding-capable grades of polymers include a nylon, an EVOH, an extrudable PET, or copolyesters.

The first layer 122 may optionally comprise one or more additional additives. Suitable additives include additives compatible with polymers. For example, suitable additives may include, but are not limited to, oxygen scavenger additives such as cycloolefin polymers and copolymers and unsaturated polyolefins. Examples of suitable additives include those sold by BP Amoco Chemicals under the AMOSORB® name and iron oxide formulations such as those sold by Mitsubishi Gas Chemical Company under the AGELESS® name. According to one embodiment, the additives are suitable for and approved for use with foodstuffs.

In this embodiment, the second layer 124 is an interior layer (e.g., a “tie layer”) that comprises (and, in particular embodiments, consists of, and/or consists essentially of) an adhesive or tie-layer resin suitable for bonding extrusion blow-molding-capable grades of polymers and polyolefins. This adhesive or tie-layer resin may comprise, for example, a maleic anhydride-modified polyolefin, such as maleic anhydride-modified polyethylenes (PE), including modified medium density polyethylenes (MDPE), low density polyethylenes (LDPE) and linear low density polyethylenes (LLDPE), and maleic anhydride-modified polypropylenes (PP). Commercially available suitable adhesives include those sold by Rohm & Haas under the TYMOR™ name, those sold by Equistar Chemicals under the PLEXAR® name including PLEXAR® PX 6002 and PLEXAR® PX 3236, and those sold by Mitsui Chemicals under the ADMER® name.

In the embodiment shown in FIG. 2, the container wall's third layer 126 comprises (and, in other particular embodiments, consists of, and/or consists essentially of) polyethylene, virgin polyolefin and/or regrind material from monolayer or multilayer polyolefin bottles, or other suitable polymers. Preferably, regrind material comprises pre-consumer scrap and/or part generated flash from one or more containers that have a composition that is similar to (and preferably substantially the same as) that of the container itself (and/or one of the container's walls). For example, according to one embodiment, the container comprises a first layer 122 comprising an extrusion blow-molding-capable grade of polymer, a second layer 124 comprising an adhesive comprising a maleic anhydride-modified polyolefin, and a third layer 126 comprising polyethylene such as high density polyethylene (HDPE). According to another embodiment, the container comprises a first layer 122 comprising an extrusion blow-molding-capable grade of polymer such as Nylon or EVOH, a second layer 124 comprising a maleic anhydride-modified polyolefin, and a third layer 126 comprising regrind from the extrusion blow-molding-capable grade of polymer/adhesive/HDPE composition. In a preferred embodiment, the regrind material comprises (and, in particular embodiments, consists of, and/or consists essentially of) flash material from one or more containers of the same type as the container. In some embodiments, the regrind material comprises (and, in particular embodiments, consists of, and/or consists essentially of) flash material from one or more containers that are produced at the same manufacturing facility as the container (e.g., containers produced on the same production line as the container).

The third layer 126 may also include an additional amount of a suitable adhesive.

Suitable adhesives for the third layer 126 include the adhesives or tie-layer resins disclosed above comprising, for example, maleic anhydride-modified polyolefin. Where the third layer 126 includes regrind material, the regrind melt preferably includes a suitable adhesive, more preferably the same adhesive as was used in production of the material used as regrind. Where the third layer 126 includes adhesive and regrind, the adhesive is preferably added to the regrind melt prior to extrusion. The amount of adhesive added to the regrind melt may vary and may be adjusted to optimize a property of the third layer, such as brittleness, adhesion, or gloss. In particular embodiments, the amount of adhesive added is suitable to prevent brittleness and breakage of the container during the extrusion process and normal use of the container. The amount of adhesive added to the regrind melt is preferably about 0.5% to about 10% by weight, more preferably about 1% to about 5%, most preferably 3% to 5%, based on the weight of the regrind material. As may be understood from FIG. 2, in various embodiments, an outer side of the first layer 122 engages an inner side of the second layer 124, and an inner side of the third layer 126 engages an outer side of the second layer 124.

In particular embodiments, the third layer 126 may be an outer surface layer of the container wall 110A. However, in other embodiments, the container may include other layers that are closer to the container's exterior than the third layer 126. For example, in one embodiment, the container wall includes a fourth layer adjacent the outer surface of the third layer that serves as the outer surface layer of the container wall.

As may be understood from FIG. 3, in particular embodiments of the invention, the container wall 110B includes the first, second, and third layers 122, 124, 126 described above, and further includes an additional fourth layer 138, which may be an exterior layer of the container wall 110B. However, in other embodiments, the container may include other layers that are closer to the container's exterior than the fourth layer 138. For example, in one embodiment, the container wall 110B includes a fifth layer (not shown) adjacent the outer surface of the fourth layer 138 that serves as the outer surface layer of the container wall.

In various embodiments, the fourth layer 138 comprises (and, in particular embodiments, consists of, and/or consists essentially of) one or more polyolefins. In particular embodiments, these one or more polyolefins may be, for example, selected from a group consisting of polyethylenes and polypropylene. In particular embodiments, these one or more polyolefins may be selected from a group consisting of HDPE and polypropylene. However, in other embodiments, other suitable polyolefins may be used.

As may be understood from FIG. 3, in the embodiment shown in this figure, the second and third layers 124, 126 are disposed between the first and fourth layers 122, 138. As may also be understood from this figure, in this embodiment, an outer side of the first layer 122 engages an inner side of the second layer 124, an inner side of the third layer 126 engages an outer side of the second layer 124, and an inner side of the fourth layer 138 engages an outer side of the third layer 126.

The thicknesses and relative weight of the first layer 122, second layer 124, third layer 126, optional fourth layer 138, and other optional additional layers may vary based on the desired properties of the container, the relative costs of materials, capabilities of process equipment, and other variables. According to one embodiment, the first layer 122 comprises about 2% to about 10% by weight, more preferably about 2% to about 5%, and most preferably about 5%, based on the total weight of the extruded wall 110B of the container. According to another embodiment, the first layer 122 comprises about 2% to about 20% by weight, based on the total extruded wall weight of the container. According to another embodiment, the first layer 122 comprises more than 10% by weight of the container. According to one embodiment, the second layer 124 comprises about 0.2% to about 10%, more preferably about 0.5% to about 3%, based on the total weight of the extruded wall 110B of the container.

In particular embodiments, the container wall 110 is transparent. In other embodiments, the container wall 110 is substantially clear. In particular embodiments, the amount of flavor scalping is reduced relative to a similar HDPE container. In particular embodiments, the amount of gas transmission, including oxygen transmission, is reduced relative to a similar monolayer HDPE container.

Discussion Regarding Use of Markers for Detecting the Presence of a Particular Laminate Layer

FIGS. 2 and 3 are examples in which the exemplary detectable optical markers described herein can be embedded for layer and thickness detection. In exemplary embodiments, once the desired layer to be detected is determined, the optical marker can be added to the layer (e.g., the Nylon or EVOH inner layer) during the manufacturing process. For example, the marker can be any florescent, photosensitive, or brightener material (e.g., IR, visible and UV) that reacts when a particular spectrum of light (e.g., electromagnetic radiation, etc.) is illuminated upon the material. The marker can also be any chemical colorant embedded in the layer to be detected. For example and with reference to FIG. 2, the marker may be formed as either a laminated layer 122A with the layer to be detected or the marker may be embedded 122B (FIG. 3) or 124C (FIG. 4) within the layer to be detected. In various embodiments, the marker is added to the appropriate layer during the molding process.

As described further herein, color or UV “glow” presence can be used to indicate the presence of a particular layer that can be confirmed throughout the package inner surface visually or by electronic detection. In additional exemplary embodiments, color opacity and reflectance correlates to the thickness of the layer under investigation. The addition of the marker in the inner layer thereby allows confirmation of sufficient layer thickness for barrier properties, and allows operators to avoid using excess barrier material at higher costs. As such, by modifying the material of the layer to be detected allows the manufacturer to verify layer presence on high percentage of bottles with a visual non-destructive test at a time of production, by introducing samples of various electromagnetic spectrum blocking additives (UV, visible, IR) into the layer of interest.

It is appreciated that various colorants may be utilized in either the barrier layer, or in any other layer of the multilayer laminate. The colorants can be added at any stage during the blow molding process such as during extrusion or during the molding process. Generally, any colorant, that is dyes, which are soluble, or inorganic or organic pigments can be added. Examples of dyes include the various azo dyes, anthraquinone dyes, azine dyes, and the like. Examples of inorganic pigments which are added to the polyester to impart a color or hue thereto include titanium dioxide, carbon black, iron oxide, chromium oxide greens, iron blue, chrome green, violet pigments, ultramarine pigments, titanate pigments, pearlescent pigments, metallic pigments such as aluminum, browns, powders, and the like. Organic pigments include monazo pigments, disazo pigments, and the like. Naturally, various amounts are utilized to impart a desired color or hue and such amounts can range over a wide range. In one example, if a container implements a fill window, which is transparent to allow the user to view the level of fluid in the container, the added colorants to the desired layer would show a slight color through the fill window to alert the inspector that the layer has been added.

In addition, various optical brighteners can be implemented as described herein. Optical brighteners, optical brightening agents (OBAs), fluorescent brightening agents (FBAs) or fluorescent whitening agents (FWAs) are chemical compounds that absorb light in the ultraviolet and violet region (usually 340-370 nm) of the electromagnetic spectrum, and re-emit light in the blue region (typically 420-470 nm). Fluorescent activity is a short term or rapid emission response, unlike phosphorescence, which is a delayed emission. In particular embodiments, a suitable visible marker material is MTF 66171 Blue Barrier ID manufactured by Colortech Inc. of Ontario, Canada, a suitable UV brightener marker material is Colortech 100LM3799 Barrier ID manufactured by Colortech Inc. of Ontario, Canada and a suitable UV blocker marker is Colortech 10793-12 UV Blocker manufactured by Colortech Inc. of Ontario, Canada. It should be understood from reference to this disclosure that those marker manufactured by Colortech Inc. are examples of suitable additives and should not limit the disclosed system and methods.

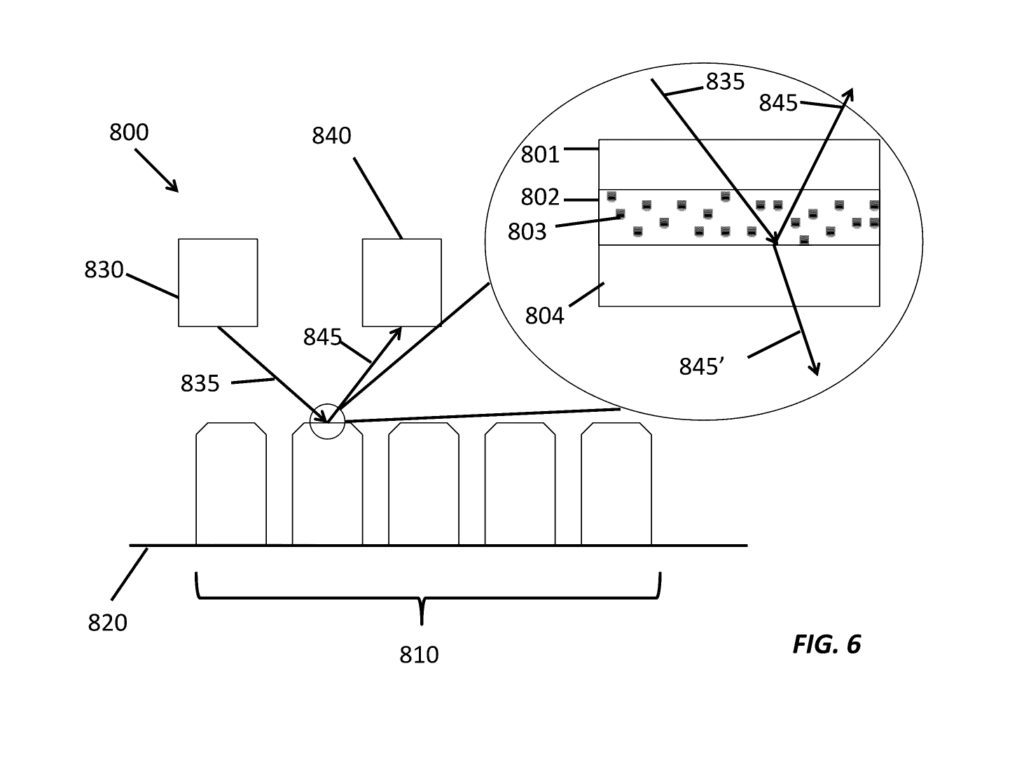

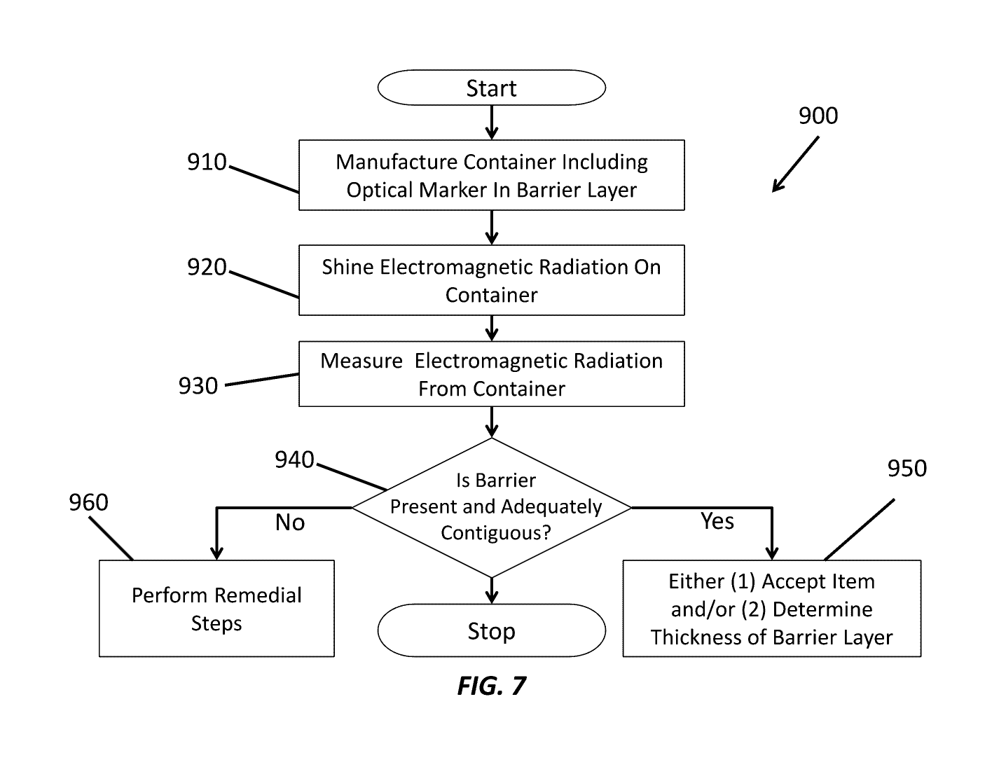

Discussion of the Embodiments of FIGS. 6 and 7, and Other Related Embodiments

Referring now to FIGS. 6 and 7, in exemplary embodiments, the systems and methods described herein are implemented to determine the presence and thickness of the barrier layer or any other layer in a multilayer laminate container (e.g., a bottle, a packaging container, etc.). As described herein, by incorporating the chemical UV brightener/colorant or other optical into the barrier layer, the operator can determine the presence and/or thickness of the layer by exposing the container to an electromagnetic spectrum (e.g., UV light), and assessing the presence and/or thickness of the coating based on the intensity of the color and/or glow that emanates from the container when it is exposed to UV light. Thus, destructive testing is no longer required to determine whether a particular plastic container includes the proper thickness of the barrier layer.

Referring now to FIG. 6, which is a barrier layer thickness measurement system 800, it is appreciated that there can be multiple containers 810 having a barrier layer that are mass produced and tested in accordance with the method 900. According to step 910 (FIG. 7), the containers are typically made using an extrusion blow-molding process. In general, the multilayer laminates may be blow-molded by conventionally known methods such as a so-called cold parison method and a so-called hot parison method. The multilayer laminate, including the optically detectable marker material, is stretched in an axial direction thereof by a mechanical means such as a core rod insertion, and then high-pressure air is blown into the multilayer laminate to subject the laminate to stretching and blow molding in a lateral direction thereof, or the method in which after crystallizing a mouth portion of the multilayer laminate and heating a surface of the multilayer laminate to a predetermined temperature, the multilayer laminate is subject to blow molding in a metal mold heated to another predetermined temperature.

In this process, molten thermoplastic material is extruded through an extrusion die head to form a substantially tubular parison. A mold is closed around the parison to pinch the parison's tail and form the bottom of the container. Pressurized air is then injected into the parison to expand it until it comes into contact with the mold's interior surface. After the formed container has cooled and solidified, the mold is opened and the finished container may be removed. The extruder or extruders used according to the invention may include, for example, any extruders suitable for multi-layer/coextruded processes, including shuttle, rotary wheel, and reciprocating-screw blow molding equipment.

In exemplary embodiments, during the blow molding process, a suitable marker as described herein can be added to any layer of the container (e.g., the barrier layer) to aid in the detection of the layer. As described herein, the systems and methods described herein enable the detection of a particular layer in a multilayer laminate. The laminate may be any multi-layer packaging in which the presence or absence of a particular layer is to be detected. For illustrative purposes, the detection of a barrier layer in blow molded wall containers has been described. It is appreciated that other types of multilayer containers and barrier layers are contemplated in other embodiments. It is appreciated that there are many types of barrier layers contemplated in various embodiments.

For example, resins having an oxygen-capturing function, which are capable of capturing oxygen within a container while preventing penetration of oxygen into the container from outside have been developed and applied to multilayer bottles. The oxygen-capturing bottles are suitably in the form of a multilayer bottle including a gas-barrier layer made of, for example, polyamide, in which a transition metal-based catalyst is blended, from the viewpoints of oxygen-absorbing rate, transparency, strength, moldability, and the like. The barrier layer may also contain one or plural kinds of other resins such as nylon, Ethylene vinyl alcohol (EVOH), polyesters, polyolefins and phenoxy resins unless the addition of these resins adversely affects the aimed effects of the present invention. In addition, the barrier layer may also contain various additives. Examples of the additives include inorganic fillers such as glass fibers and carbon fibers; plate-shaped inorganic fillers such as glass flakes, talc, kaolin, mica, montmorillonite and organized clay; impact modifiers such as various elastomers; nucleating agents; lubricants such as fatty amide-based compounds and fatty acid metal salt-based compounds; antioxidants such as copper compounds, organic or inorganic halogen-based compounds, hindered phenol-based compounds, hindered amine-based compounds, hydrazine-based compounds, sulfur-based compounds and phosphorus-based compounds; heat stabilizers; anti-coloring agents; ultraviolet absorbers such as benzotriazole-based compounds; mold release agents; plasticizers; flame retardants; oxygen capturing agents such as cobalt-containing compounds; and anti-gelling agents such as alkali compounds. In addition to the additives and agents listed above, other optically detectable marker agents and/or additives may also be added to the various layers during the manufacture of the container. It should be understood that in various embodiments, a key feature of the colorant material is to provide a means that allows a user to manually or automatically identify the presence and thickness of a layer of the laminate, while maintaining sufficient properties of the layer

In various embodiments, a colorant may be mixed with the material that forms the layer to de detected. In the case of extrusion blow molding, colorant is added to the barrier materials prior to the material being delivered to the extrusion process. In the case of PET, there is an injection molding stage prior to the blow molding stage. Thus, the barrier and colorant is added at the injection molding stage.

The containers 810 may be in an assembly line 820 and subject to testing to discern if the barrier layer is present. In such an assembly line 820, one area can be designated as the test area in which the containers 810 are tested. As described herein, the testing not only detects the absence or presence of the barrier layer (or other desirable layers), but also characteristics of the barrier layer such as the thickness. As such, the system 800 also includes any type of electromagnetic radiation source 830 that shines incident electromagnetic radiation 835 onto the containers 810, as indicated in step 920 of method 900. The system 800 further includes an electromagnetic radiation receiver 840 that receives exit electromagnetic radiation 845 from the containers 810. As described he the electromagnetic radiation 835 penetrates the barrier layer and the optical marker within the barrier layer. The incident electromagnetic radiation 835 is one of transmitted through, absorbed by or reflected by the barrier layer and exits the containers 810 as the exit radiation 845′. The exit radiation is detected and measured by the electromagnetic radiation receiver 840 at block 930 of FIG. It is appreciated that the electromagnetic radiation source 830 can be configured to generate any desirable spectrum as described herein (e.g., IR, UV, visible and the like). The electromagnetic radiation detector 840 can also be configured to detect any spectrum of electromagnetic radiation. In addition, it is appreciated that the barrier layer can include an optical marker that can merely be inspected by the naked eye.

Referring again to FIG. 7, once the electromagnetic radiation detector 840 has detected the exit radiation 845′, the method 900 determines if there is sufficient barrier thickness at block 940. It is appreciated that certain criteria can be predetermined to decide whether or not sufficient barrier thickness exists in the containers 810. For example, the incident electromagnetic radiation 835 has certain characteristics such as intensity, phase and frequency. As the incident radiation 835 interacts with the barrier layer having the optical marker, the characteristics of the incident radiation 835 are affected by h.' optical marker and are present in the exit radiation 845, whether it's by transmittance, absorbance, reflectance, and the like. In FIG. 6, the multilayer structure of the containers 810 have been simplified to illustrate a barrier layer 802 including optical markers 803 disposed between an outer layer 801 and an inner layer 804. It is appreciated that the various layer structures described herein with regards to FIGS. 2-5, as well as other multilayer structures are contemplated in the method 900. The incident electromagnetic radiation 835 is shown as internally reflected within the barrier layer 802 as exit radiation 845, or alternatively absorbed/transmitted as exit electromagnetic radiation 845′. It is appreciated that the method 900 and system 800 can be set up in a variety of measurement configurations.

At step 940, the system determines whether the barrier layer is present and whether the barrier layer is adequately contiguous throughout the container. In various embodiments, the system may also determine the thickness of the barrier layer. As such, the system may determine whether there is a sufficient barrier layer thickness by comparing the characteristics of the incident electromagnetic radiation 835, and the characteristics of the exit electromagnetic radiation 845. It is appreciated that there exists predetermined tables that describe how radiation is affected depending on both thickness and optical marker qualities. As such, the thickness of the barrier layer 802 (and other qualities) can be extrapolated by the effects on the exit electromagnetic radiation 845 as compared to the incident electromagnetic radiation 835, and determined at block 950. It is appreciated that there also may be a predetermined thickness range that determines whether or not the barrier layer thickness is sufficient. If at block 940, it is determined that there is not a sufficient barrier thickness, then remedial steps can be performed at block 960. For example, the containers 810 with missing or insufficient barrier layer thicknesses can be removed and discarded. Data can be taken to adjust barrier layer thickness for the next batch of containers. It is also appreciated that the barrier layer 802 can be thick beyond a necessary and sufficient thickness. As such, remedial measures can include decreasing barrier thickness thereby realizing cost savings.

The remaining FIGS. 4-5 describe alternate multilayer laminates in which the optical markers and detection methods described herein can be implemented.

Discussion of the Embodiments of FIGS. 4 and 5, and Other Related Embodiments

In the embodiment shown in FIG. 4, the first layer 142 of the container wall 110C is an inner surface layer of the container wall 110C and comprises (and, in various embodiments, consists of, and/or consists essentially of) an extrusion blow-molding-capable grade of polymer. Suitable extrusion blow-molding-capable grades of polymers include those provided for the embodiments of FIGS. 2 and 3 above. In this embodiment, the second layer 144 is an interior layer that comprises (and, in particular embodiments, consists of, and/or consists essentially of) polyamide resin. Suitable polyamide resins include nylon 6, nylon 66, Nylon-MXD6, and nylon-clay nanocomposites, including such commercially available products from EMS-Grivory, from Honeywell under the AEGIS™ name, and from Mitsubishi Gas Chemical.

In particular embodiments, the container wall's third layer 146 comprises (and, in particular embodiments, consists of, and/or consists essentially of) an extrusion blow-molding-capable grade of polymer. In particular embodiments, the third layer 146 may be an outer surface layer of the container wall 110C. However, in other embodiments, the container may include other layers that are closer to the container's exterior than the third layer 146. For example, in one embodiment, the container wall 110C includes a fourth layer (not shown) adjacent the outer surface of the third layer 146 that serves as the outer surface layer of the container wall 110C. As may be understood from FIG. 4, in various embodiments, an outer side of the first layer 142 engages an inner side of the second layer 144, and an inner side of the third layer 146 engages an outer side of the second layer 144.

In alternative embodiments of the container wall discussed above in regard to FIG. 4, the container wall's second layer 144 (or any of the container wall's other layers) may have a different composition than the composition described above in regard to FIG. 4. For example, in particular embodiments such as the embodiment of the container wall 110D shown in FIG. 5, the container wall's second layer 144 comprises (and, in particular embodiments, consists of, and/or consists essentially of) at least one ethylene vinyl alcohol copolymer (EVOH). Commercially available EVOH's include those available from Kurarary Co. and Eval Company of America under the EVAL® name and those available from Soarus under the SOARNOL® name.

In the embodiment shown in FIG. 5, the structure and composition of the other aspects of the container wall (e.g., the structure and composition of the first and third layers 142, 146) are the same as those described above with regard to the embodiment discussed above in regard to

FIG. 4. In alternative embodiments, the second layer 144 comprises at least one PET-compatible oxygen scavenger. As used herein, PET-compatible refers to materials that adhere to or may be blended with PET without requiring an additional adhesive layer. Suitable PET-compatible oxygen scavengers include cycloolefin polymers and copolymers and unsaturated polyolefins, including those commercially available from BP Amoco Chemicals under the AMOSORB® name. It should be understood that, in other embodiments, the structure and composition of the other aspects of the container wall (e.g., the structure and composition of the first and third layers 142, 146) may be different than those described above with regard to the embodiment discussed above in regard to FIG. 4.

Referring again to FIG. 1, in particular embodiments, the container wall 110 is transparent. In other embodiments, the container wall 110 is substantially clear. In particular embodiments, the amount of flavor scalping is reduced relative to a similar HDPE container. In particular embodiments, the amount of gas transmission, including oxygen transmission, is reduced relative to a similar HDPE container. In particular embodiments, the amount of gas transmission, including oxygen transmission, is reduced relative to a similar monolayer PET container.

It should be understood that the detectable optical marker described above may be embedded or co-extruded with any of the layers described with respect to FIGS. 4-5 to allow a user to detect the presence of or thickness of the particular layer.

### Advantages of Various Selected Embodiments of the Invention

Various embodiments of the invention may include one or more of the following advantages over prior art containers: (1) destructive testing is no longer required to determine whether a particular plastic container includes the proper thickness of the barrier coating; (2) the ability to measure not only the presence of a particular layer, but also the thickness of a particular layer; and (3) reduced cost by the reduction of thicknesses of particular layers because sufficient layer thickness is identified. It should be understood that particular embodiments of the invention may include advantageous characteristics other than those listed above and that some embodiments may include none of the above advantageous characteristics.

### CONCLUSION

Many modifications and other embodiments of the invention will come to mind to one skilled in the art to which this invention pertains having the benefit of the teachings presented in the foregoing descriptions and the associated drawings. Accordingly, it should be understood that the invention is not to be limited to the specific embodiments disclosed and that modifications and other embodiments are intended to be included within the scope of the appended exemplary concepts. Although specific terms are employed herein, they are used in a generic and descriptive sense only and not for the purposes of limitation.

What is claimed is:

1. A blow molded container comprising a laminate wall, said wall comprising:
a. a first layer comprising an extrusion blow-molding-capable grade of polymer, said first layer being an inner surface layer of said wall;
b. a second, interior layer, said second layer comprising a detectable optical marker embedded in the second interior layer; and
c. a third layer comprising an extrusion blow-molding-capable grade of polymer; and
d. a detectable optical marker layer that is embedded in, or laminated with, one of the first layer, the second layer or the third layer during manufacture of the container,
wherein said second layer is disposed between said first and third layers.

2. The blow molded container of claim 1, wherein said third layer is an outer surface layer of said wall.

3. The blow molded container of claim 1, wherein said first layer engages an inner side of said second layer; and said third layer engages an outer side of said second layer.

4. The blow molded container of claim 3, wherein said third layer is an exterior surface layer of said wall.

5. The blow molded container of claim 1 wherein the second interior layer is a barrier material.

6. The blow molded container of claim 5, wherein said barrier material is selected from a group consisting of: (A) polyamide resin; (B) nylon; (C) EVOH; and (D) one or more oxygen scavengers.

7. The blow molded container of claim 1 wherein the detectable optical marker is one of an ultraviolet brightener or a chemical colorant.

8. The blow molded container of claim 1 wherein the detectable optical marker is a photo-luminescent material that is co-extruded with the one of the first layer, the second layer or the third layer.

9. The blow molded container of claim 1 wherein the detectable optical marker is a visible chemical colorant.

10. A method of detecting the presence of layer within a co-extruded, blow molded container wall, the method comprising:
a. manufacturing a container body comprising at least one co-extruded, blow molded wall comprising multiple layers, wherein one of the multiple layers comprises a detectable optical marker;
b. shining incident electromagnetic radiation on the multilayer laminate container body; and
c. visually detecting the presences of the detectable marker to provide evidence that a particular layer of the multiple layers is present in the at least one co-extruded, blow molded wall.

11. The method of claim 10, further comprising the steps of:
a. measuring an exit radiation from the container body; and
b. determining if there exists a sufficient thickness of the one of the multiple layers comprising the detectable optical marker based on characteristics of the exit radiation.

12. The method of claim 10 wherein the multilayer co-extruded, blow molded container wall comprises:
a. a first layer comprising an extrusion blow-molding-capable grade of polymer, said first layer being an inner surface layer of said wall;
b. a second, interior layer, said second layer comprising a detectable optical marker embedded in the second interior layer; and
c. a third layer comprising an extrusion blow-molding-capable grade of polymer, wherein said second layer is disposed between said first and third layers.

13. The method of claim 10 wherein the detectable optical marker is a florescent material that is added during the molding process.

14. The method of claim 10 wherein the detectable optical marker is a photo-luminescent material.

15. The method of claim 10 wherein the detectable optical marker is a visible colorant.

16. The method of claim 10 wherein the second interior layer is a barrier layer.

17. The method of claim 10, wherein said barrier material is selected from a group consisting of: (A) polyamide resin; (B) EVOH; and (C) one or more oxygen scavengers.

18. A blow molded container comprising:
a co-extruded, multi-layer, blow molded wall comprising at least one layer that comprises about 0.2% to about 10% of the total weight of the extruded wall of the container and a blend of:
(A) an extrusion-blow-molding-capable grade of polymer;
(B) at least one barrier material having a detectable optical marker therein; and
(C) regrind from at least a particular multi-layer container,
said particular multi-layer container comprising at least one layer of an extrusion-blow-molding-capable grade of polymer.

19. The blow molded container of claim 18, wherein said barrier material is selected from a group consisting of: (A) polyamide resin; (B) EVOH; and (C) one or more oxygen scavengers.

20. The blow molded container of claim 18 wherein the detectable optical marker is at least one of a florescent material, a photo-luminescent material, and a visible chemical colorant.

21. A layer thickness measurement system, comprising:
a. an electromagnetic radiation source;
b. an electromagnetic radiation detector;
c. a multi-layer laminate container, comprising:
i. a first layer comprising an extrusion blow-molding-capable grade of polymer, said first layer being an inner surface layer of said wall;
ii. a second, interior layer, said second layer;
iii. a third layer comprising an extrusion blow-molding-capable grade of polymer, wherein said second layer is disposed between said first and third layers; and
iv. a detectable optical marker in one of the first, second or third layers,
wherein electromagnetic radiation incident from the electromagnetic radiation source on the multi-layer laminate container generates exit electromagnetic radiation that is adapted to be detected by the electromagnetic radiation detector, the exit radiation determining one of a thickness of the one of the first, second and third layers and/or the presence of the one of the first, second, or third layers in the multi-layer laminate container.
